(19) United States
(12) Patent Application Publication
(10) Pub. No.: US 2025/0274839 A1
(43) Pub. Date: Aug. 28, 2025

(54) Methods For Enhanced Policy Control For Traffic Steering And Switching Between Multiple Mobile Subscriptions

(71) Applicant: MediaTek Inc., Hsinchu City (TW)

(72) Inventors: Chia-Lin Lai, Hsinchu City (TW); Yu-Hsin Lin, Hsinchu City (TW); Yuan-Chieh Lin, Hsinchu City (TW)

(21) Appl. No.: 19/034,588

(22) Filed: Jan. 23, 2025

Related U.S. Application Data
(60) Provisional application No. 63/556,903, filed on Feb. 23, 2024.

(51) Int. Cl. H04W 40/22; H04W 48/18; H04W 60/00; H04W 84/04; H04W 84/06

(52) U.S. Cl. CPC H04W 40/22; H04W 48/18; H04W 60/005; H04W 84/042; H04W 84/06

(57) ABSTRACT

Various solutions for enhanced policy control for traffic steering and switching between multiple mobile subscriptions are described. A network node may determine that two mobile subscriptions have been registered to a same wireless network or different wireless networks and the mobile subscriptions are associated with an apparatus supporting traffic steering or switching between the mobile subscriptions. Then, the network node may generate a control policy for traffic steering or switching between the mobile subscriptions and provide the control policy to the apparatus.

### CROSS REFERENCE TO RELATED PATENT APPLICATION(S)

The present disclosure is part of a non-provisional application claiming the priority benefit of U.S. Patent Application No. 63/556,903, filed 23 Feb. 2024, the content of which herein being incorporated by reference in its entirety.

### TECHNICAL FIELD

The present disclosure is generally related to mobile communications and, more particularly, to enhanced policy control for traffic steering and switching between multiple mobile subscriptions.

### BACKGROUND

Unless otherwise indicated herein, approaches described in this section are not prior art to the claims listed below and are not admitted as prior art by inclusion in this section.

A public land mobile network (PLMN) is a network established and operated by an administration or recognized operating agency (ROA) for the specific purpose of providing land mobile communication services to the public. PLMN provides communication possibilities for mobile users. A PLMN may provide service in one or a combination of frequency bands. Access to PLMN services is achieved by means of an air interface involving radio communications between mobile phones and base stations with integrated internet protocol (IP) network services. One PLMN may include multiple radio access networks (RANs) utilizing different radio access technologies (RATs) for accessing mobile services. RAN is part of a mobile communication system, which implements a radio access technology. Conceptually, RAN resides between mobile devices and provides connection with its core network (CN). Depending on the (3^{rd} generation partnership project (3GPP)) standards, mobile phones and other wireless connected devices are varyingly known as user equipment (UE), terminal equipment (TE), mobile stations (MS), or mobile termination (MT), etc. Examples of different RATs include 2^{nd} generation (2G) Global System for Mobile Communications (GSM), 3^{rd} generation (3G) Universal Mobile Telecommunications System (UMTS), 4^{th} generation (4G) Long Term Evolution (LTE), 5th generation (5G) New Radio (NR), and other non-3GPP access RATs such as Wireless-Fidelity (Wi-Fi).

Generally, a UE may obtain mobile services by using one or more mobile subscriptions (e.g., universal subscriber identity modules (USIMs)) to register with one or more PLMNs. However, under the current framework of 4G LTE or 5G NR, there is no control policy to guide the UE in traffic steering and/or switching between multiple mobile subscriptions. Take a UE with one mobile subscription registered to PLMN #1 of RAT #1 and another mobile subscription registered to PLMN #2 of RAT #2 for example. When an application on the UE needs to send data packets, the UE would not know how to determine which subscription or which PLMN/RAT to send the data packets for the application, i.e., not knowing how to steer/switch the application's traffic between these two mobile subscriptions. A common practice would rely on the user to manually select one specific mobile subscription or one specific PLMN/RAT to serve the application's need, but this solution is not ideal in terms of service efficiency and it lacks the flexibility of network control.

Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and/or apparatus pertaining to enhanced policy control for traffic steering and switching between multiple mobile subscriptions. It is believed that the above-described issue would be avoided or otherwise alleviated by implementing one or more of the proposed schemes described herein.

In one aspect, a method may involve a network node determining that two mobile subscriptions have been registered to a same wireless network or different wireless networks and the mobile subscriptions are associated with an apparatus supporting traffic steering or switching between the mobile subscriptions. The method may also involve the network node generating a control policy for traffic steering or switching between the mobile subscriptions. The method may further involve the network node providing the control policy to the apparatus.

In one aspect, a method may involve an apparatus registering two mobile subscriptions to a same wireless network or different wireless networks, wherein the mobile subscriptions are associated with the apparatus supporting traffic steering or switching between the mobile subscriptions. The method may also involve the apparatus receiving a control policy from a network node. The method may further involve the apparatus performing traffic steering or switching between the mobile subscriptions based on the control policy.

It is noteworthy that, although description provided herein may be in the context of certain radio access technologies, networks and network topologies such as Long-Term Evolution (LTE), LTE-Advanced, LTE-Advanced Pro, 5th Generation (5G), New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting an example scenario of a communication environment in which various solutions and schemes in accordance with the present disclosure may be implemented.

FIG. 2 is a diagram depicting an example scenario of dual-steer policy generation/configuration in accordance with an implementation of the present disclosure.

FIG. 3 is a diagram depicting another example scenario of dual-steer policy generation/configuration in accordance with an implementation of the present disclosure.

FIG. 4 is a block diagram of an example communication system in accordance with an implementation of the present disclosure.

FIG. 5 is a flowchart of an example process in accordance with an implementation of the present disclosure.

FIG. 6 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to enhanced policy control for traffic steering and switching between multiple mobile subscriptions. According to the present disclosure, a number of possible solutions may be implemented separately or jointly. That is, although these possible solutions may be described below separately, two or more of these possible solutions may be implemented in one combination or another.

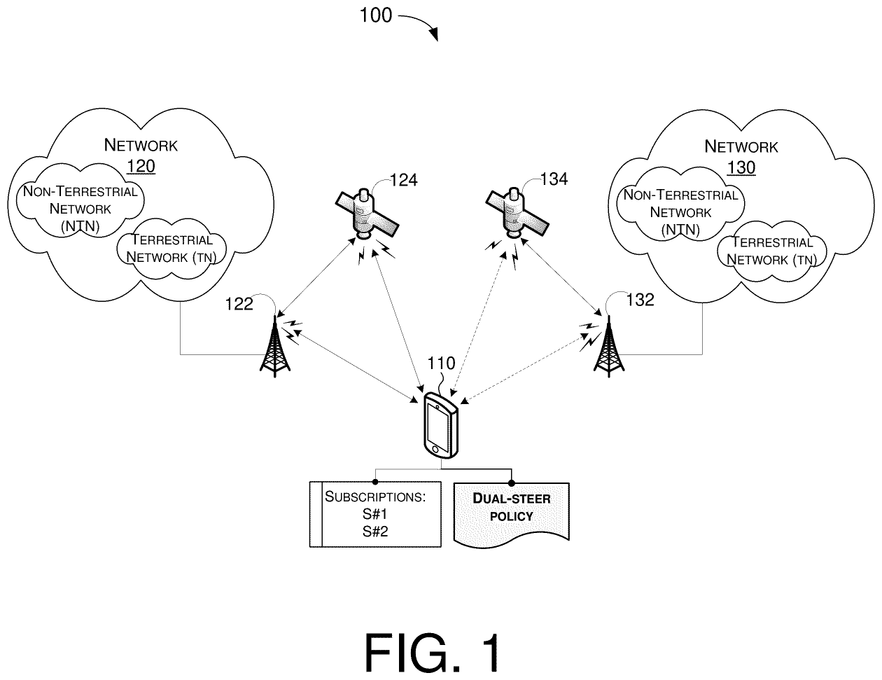

FIG. 1 illustrates an example scenario 100 of a communication environment in which various solutions and schemes in accordance with the present disclosure may be implemented. Scenario 100 involves a dual-steer device 110 in wireless communication with a network 120 (e.g., a wireless network, such as a public land mobile network (PLMN), including a non-terrestrial network (NTN) and/or a TN) via at least a terrestrial network node 122 (e.g., a base station (BS) such as an evolved Node-B (eNB), a Next Generation Node-B (gNB), or a transmission/reception point (TRP)) and/or at least a non-terrestrial network node 124 (e.g., a satellite), and optionally with another network 130 (e.g., a wireless network, such as a PLMN, including an NTN and/or a TN) via at least a terrestrial network node 132 (e.g., a BS such as an eNB, a gNB, or a TRP) and/or at least a non-terrestrial network node 134 (e.g., a satellite). For example, the terrestrial network node 122/132 may form a TN serving cell for wireless communication with the dual-steer device 110, or the non-terrestrial network node 124/134 may form an NTN serving cell for wireless communication with the dual-steer device 110. In some implementations, each of the networks 120 and 130 may be a 4G/5G/B5G/6G network, and the dual-steer device 110 may be a smartphone, a tablet computer, a laptop computer or a notebook computer. Alternatively, each of the networks 120 and 130 may be an IoT/NB-IoT/IIoT network, and the dual-steer device 110 may be an IoT device such as an NB-IoT UE or an enhanced machine-type communication (eMTC) UE (e.g., a bandwidth reduced low complexity (BL) UE or a coverage enhancement (CE) UE). Although not shown, the TN part of the network 120/130 may include a core network (CN) containing various network functions (NFs). For example, if the network 120/130 is a 5G system (5GS), the NFs may include an access and mobility function (AMF), a session management function (SMF), a policy control function (PCF), an operations and maintenance (OAM) entity, a network data analytics function (NWDAF), an application function (AF), a unified data management (UDM), a unified data repository (UDR), and an energy information function (EIF), etc. In such communication environment, the dual-steer device 110, the network 120/130, the terrestrial network node 122/132, and/or the non-terrestrial network node 124/134 may implement various schemes pertaining to enhanced policy control for traffic steering and switching between multiple mobile subscriptions in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

More specifically, the dual-steer device 110 is a device supports the feature of traffic steering and/or switching between two mobile subscriptions (denoted as S #1 and S #2). Both the mobile subscriptions may be provided by the same PLMN (e.g., home PLMN (HPLMN)), mobile network operator (MNO), or subscription owner network. Each mobile subscription may refer to subscription data such as universal subscriber identity module (USIM), subscription permanent identifier (SUPI), international mobile subscriber identity (IMSI), subscriber concealed identifier (SUCI), or 4G/5G globally unique temporary identifier (GUTI), etc. For example, the dual-steer device 110 may contain a single UE embedded with two mobile subscriptions for non-simultaneous transmission, or contain separate UEs, each of which is associated with a respective mobile subscription for simultaneous transmission. In order to obtain mobile services (e.g., for application data transmissions and receptions), the dual-steer device 110 may register both the mobile subscriptions to the same network 120/130 or may register each of the mobile subscriptions to a respective network (e.g., S #1 being registered to network 120 and S #2 being registered to network 130, or vice versa). However, when an application needs to send data packets, the dual-steer device 110 will need guidance regarding which mobile subscription or which PLMN/RAT to send (i.e., to steer or switch) the application's data packets.

In view of the above, the present disclosure proposes a number of schemes pertaining to enhanced policy control for traffic steering and switching between multiple mobile subscriptions. According to the schemes of the present disclosure, a dual-steer device (e.g., the dual-steer device 110) may be provided with a dual-steer policy, i.e., a control policy for traffic steering and/or switching between two mobile subscriptions. For example, the dual-steer policy may be provided by (e.g., a network node such as AMF/PCF of) the HPLMN (or equivalent HPLMN (EHPLMN) or equivalent PLMN of the HPLMN/EHPLMN), the MNO, or the subscription owner network (e.g., through the registered PLMN), when the HPLMN/MNO/subscription owner network knows that the two registered mobile subscriptions are associated with the same dual-steer device. Accordingly, when an application on the dual-steer device (or on one UE within the dual-steer device) needs to send data packets, the dual-steer device (or one UE within the dual-steer device) may be able to determine, based on the dual-steer policy, which mobile subscription or which PLMN/RAT to send the data packets for the application. That is, with the dual-steer policy, the dual-steer device (or each UE of the dual-steer device) may know how to steer and/or switch the application's traffic between these two mobile subscriptions.

In some implementations, the dual-steer policy may contain at least one of the following: (i) an indication that a TN access has a higher priority than an NTN access or that the NTN access has a higher priority than the TN access; (ii) an indication that HPLMN has higher priority than visited public land mobile network (VPLMN) or that VPLMN has higher priority than HPLMN; (iii) a prioritized list of one or more application-based entries.

In some implementations, each of the application-based entries may contain a traffic descriptor for an application and a prioritized list of traffic steering/switching rules for the application.

In some implementations, the traffic descriptor may contain at least one of the following: (i) an application identifier (ID); (ii) a single-network slice selection assistance information (S-NSSAI); (iii) a data network name (DNN); (iv) an internet protocol (IP) address; and (v) a fully-qualified domain name (FQDN).

In some implementations, each of the traffic steering/switching rules may contain at least one of the following: (i) one or more PLMN IDs, or a range of PLMN ID, or one or more mobile country codes (MCCs), or a range of MCC, or wildcard PLMN or MCC, or one or more cell IDs or tracking area (TA) IDs, or one or more validity times, or one or more validity areas; (ii) one or more RATs (e.g., next-generation RAN (NG-RAN), evolved-universal terrestrial radio access network (E-UTRAN), satellite NG-RAN, satellite E-UTRAN, and UMTS, etc.) and/or (3GPP or non-3GPP) access information; (iii) one or more categories/types of RAT information (e.g., TN category, NTN category, and IoT NTN category, etc.); and (iv) an indication of primary or secondary mobile subscription (e.g., SUPI, IMSI, SUCI, 4G/5G-GUTI, USIM).

In some implementations, each validity time may contain at least one of the following: (i) a starting time; (ii) an ending time; (iii) a starting day/date; (iv) an ending day/date; and (v) a day of week.

In some implementations, each validity area may indicate at least one of the following: (i) 3GPP location; and (ii) geolocation. The 3GPP location may contain at least one of the following: (i) a PLMN ID; (ii) a radio access technology (RAT); (iii) a TA or a routing area (RA); (iv) a frequency band; (v) a tracking area code (TAC); (vi) an evolved-universal terrestrial radio access (E-UTRA) cell identity (CI); and (vii) an NR CI.

In some implementations, different HPLMN/MNO/subscription owner network may apply different principles regarding how to generate/configure the dual-steer policy. For example, an HPLMN may generate the dual-steer policy based on at least one of the following: (a) a principle that traffic of applications is preferred to be transmitted over TN access when the mobile subscriptions have been registered on both TN access and NTN access; (b) a principle that traffic of applications is preferred to be transmitted over HPLMN than VPLMN; and (c) the currently registered network(s) and corresponding access information. In the case where principle (c) is applied, when the dual-steer device changes PLMN/RAT due to mobility or other conditions (e.g., network congestion, or out of service, etc.), the HPLMN/MNO/subscription owner network may update the dual-steer policy accordingly.

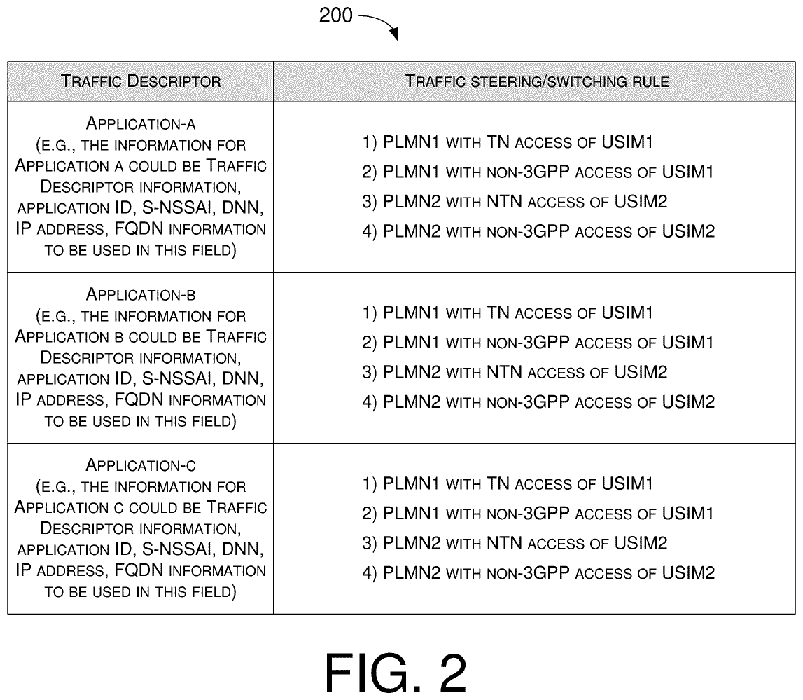

FIG. 2 illustrates an example scenario 200 of dual-steer policy generation/configuration in accordance with an implementation of the present disclosure. Scenario 200 depicts the case of a dual-steer device containing two separate UEs, where UE1/USIM1 (e.g., primary subscription) is registered to PLMN1 on TN access (e.g., NR/NG-RAN, E-UTRAN), UE2/USIM2 (e.g., secondary subscription) is registered to PLMN2 on NTN access (e.g., satellite NG-RAN, satellite E-UTRAN, IoT NTN access, etc.), and PLMN1 and PLMN2 are not the HPLMN/MNO/subscription owner network that provides these two USIMs. Assume that the HPLMN/MNO/subscription owner network provides the dual-steer policy by applying principles (a) and (b) as above-described. As shown in FIG. 2, the dual-steer policy contains a list of application-based entries, where each entry contains a traffic descriptor for a respective application and a prioritized list of traffic steering/switching rules for the application. For each application (e.g., application-a/b/c), the same prioritized list of traffic steering/switching rules is generated. Specifically, rule #1 (with the highest priority) indicates that PLMN1 with TN access of USIM1 should be used for sending the application's traffic, rule #2 (with the second highest priority) indicates that PLMN1 with non-3GPP access of USIM1 should be used for sending the application's traffic, rule #3 (with the third highest priority) indicates that PLMN2 with NTN access of USIM2 should be used for sending the application's traffic, and rule #4 (with the lowest priority) indicates that PLMN2 with non-3GPP access of USIM2 should be used for sending the application's traffic. That is, the dual-steer device may evaluate the dual-steer policy when determining which mobile subscription and which PLMN/RAT to send the application's traffic. In this case, since rule #1 is the highest priority rule and it meets the current status of USIM1, the dual-steer device may first apply this rule for the corresponding application. Later on, if the dual-steer device detects an out-of-service condition of PLMN1 over the TN access with USIM1, the dual-steer device may apply rule #3 (rule #2 is skipped because it does not meet the current status of USIM1) and accordingly, switch the application's traffic to PLMN2 over the NTN access with USIM2.

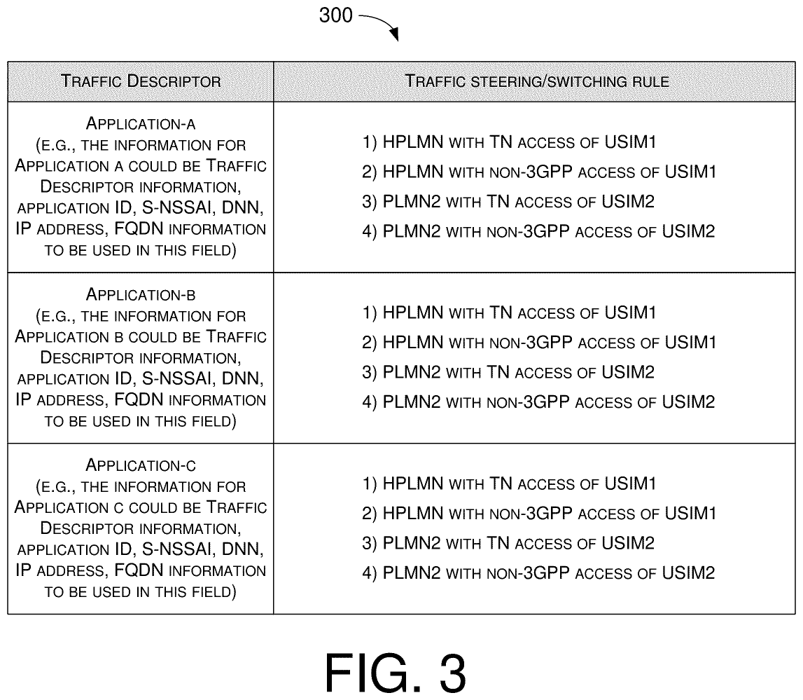

FIG. 3 illustrates an example scenario dual-steer policy generation/configuration in accordance with an implementation of the present disclosure. Scenario 300 depicts the case of a dual-steer device containing two separate UEs, where UE1/USIM1 (e.g., primary subscription) is registered to HPLMN on TN access (e.g., NR, EUTRA), UE2/USIM2 (e.g., secondary subscription) is registered to PLMN2 on TN access, and PLMN2 is a VPLMN, i.e., not the HPLMN/MNO/subscription owner network that provides these two USIMs. Assume that the HPLMN/MNO/subscription owner network provides the dual-steer policy by applying principles (a) and (b) as above-described. As shown in FIG. 3, rule #1 (with the highest priority) indicates that HPLMN with TN access of USIM1 should be used for sending the application's traffic, rule #2 (with the second highest priority) indicates that HPLMN with non-3GPP access of USIM1 should be used for sending the application's traffic, rule #3 (with the third highest priority) indicates that PLMN2 with TN access of USIM2 should be used for sending the application's traffic, and rule #4 (with the lowest priority) indicates that PLMN2 with non-3GPP access of USIM2 should be used for sending the application's traffic. That is, the dual-steer device may evaluate the dual-steer policy when determining which mobile subscription and which PLMN/RAT to send the application's traffic. In this case, since rule #1 is the highest priority rule and it meets the current status of USIM1, the dual-steer device may first apply this rule for the corresponding application. Later on, if the dual-steer device detects an out-of-service condition of HPLMN over the TN access with USIM1, the dual-steer device may apply rule #3 (rule #2 is skipped because it does not meet the current status of USIM1) and accordingly, switch the application's traffic to PLMN2 over the TN access with USIM2.

### Illustrative Implementations

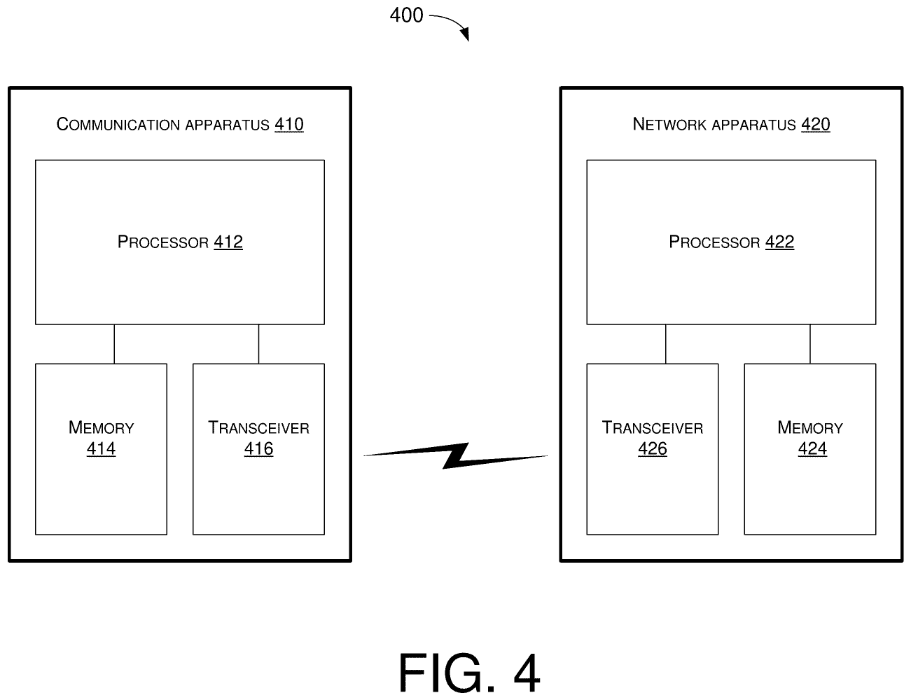

FIG. 4 illustrates an example communication system 400 having an example communication apparatus 410 and an example network apparatus 420 in accordance with an implementation of the present disclosure. Each of communication apparatus 410 and network apparatus 420 may perform various functions to implement schemes, techniques, processes and methods described herein pertaining to enhanced policy control for traffic steering and switching between multiple mobile subscriptions, including scenarios/schemes described above as well as processes 500 and 600 described below.

Communication apparatus 410 may be a part of an electronic apparatus, which may be a dual-steer device containing one or more UEs such as a portable or mobile apparatus, a wearable apparatus, a wireless communication apparatus or a computing apparatus. For instance, communication apparatus 410 may be implemented in a smartphone, a smartwatch, a personal digital assistant, an electronic control unit (ECU) in a vehicle, a digital camera, or a computing equipment such as a tablet computer, a laptop computer or a notebook computer. Communication apparatus 410 may also be a part of a machine type apparatus, which may be an IoT, NB-IoT, eMTC, IIoT UE such as an immobile or a stationary apparatus, a home apparatus, a roadside unit (RSU), a wire communication apparatus or a computing apparatus. For instance, communication apparatus 410 may be implemented in a smart thermostat, a smart fridge, a smart door lock, a wireless speaker or a home control center. Alternatively, communication apparatus 410 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 410 may include at least some of those components shown in FIG. 4 such as a processor 412, for example. Communication apparatus 410 may further include one or more other components not pertinent to the proposed schemes of the present disclosure (e.g., internal power supply, display device and/or user interface device), and, thus, such component(s) of communication apparatus 410 are neither shown in FIG. 4 nor described below in the interest of simplicity and brevity.

Network apparatus 420 may be a part of an electronic apparatus, which may be a network node such as a satellite, a BS, a small cell, a router, a gateway, or a CN NF (e.g., AMF/PCF) of a 4G/5G/B5G/6G, NR, IoT, NB-IoT or IIoT network. Alternatively, network apparatus 420 may be implemented in the form of one or more IC chips such as, for example and without limitation, one or more single-core processors, one or more multi-core processors, or one or more RISC or CISC processors. Network apparatus 420 may include at least some of those components shown in FIG. 4 such as a processor 422, for example. Network apparatus 420 may further include one or more other components not pertinent to the proposed scheme of the present disclosure (e.g., internal power supply, display device and/or user interface device), and, thus, such component(s) of network apparatus 420 are neither shown in FIG. 4 nor described below in the interest of simplicity and brevity.

In one aspect, each of processor 412 and processor 422 may be implemented in the form of one or more single-core processors, one or more multi-core processors, or one or more CISC processors. That is, even though a singular term “a processor” is used herein to refer to processor 412 and processor 422, each of processor 412 and processor 422 may include multiple processors in some implementations and a single processor in other implementations in accordance with the present disclosure. In another aspect, each of processor 412 and processor 422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 412 and processor 422 is a special-purpose machine specifically designed, arranged and configured to perform specific tasks, including enhanced policy control for traffic steering and switching between multiple mobile subscriptions, in a device (e.g., as represented by communication apparatus 410) and a network node (e.g., as represented by network apparatus 420) in accordance with various implementations of the present disclosure.

In some implementations, communication apparatus 410 may also include a transceiver 416 coupled to processor 412 and capable of wirelessly transmitting and receiving data. In some implementations, transceiver 416 may be capable of wirelessly communicating with different types of UEs and/or wireless networks of different RATs. In some implementations, transceiver 416 may be equipped with a plurality of antenna ports (not shown) such as, for example, four antenna ports. That is, transceiver 416 may be equipped with multiple transmit antennas and multiple receive antennas for multiple-input multiple-output (MIMO) wireless communications. In some implementations, network apparatus 420 may also include a transceiver 426 coupled to processor 422. Transceiver 426 may include a transceiver capable of wired/wirelessly transmitting and receiving data. In some implementations, transceiver 426 may be capable of wired communicating with other network nodes (e.g., AMF, UDM, or gNB, etc.) to determine the registration statuses of different mobile subscriptions and to provide the dual-steer policy to communication apparatus 410.

In some implementations, communication apparatus 410 may further include a memory 414 coupled to processor 412 and capable of being accessed by processor 412 and storing data therein. In some implementations, network apparatus 420 may further include a memory 424 coupled to processor 422 and capable of being accessed by processor 422 and storing data therein. Each of memory 414 and memory 424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 414 and memory 424 may include a type of read-only memory (ROM) such as mask ROM, programmable ROM (PROM), erasable programmable ROM (EPROM) and/or electrically erasable programmable ROM (EEPROM). Alternatively, or additionally, each of memory 414 and memory 424 may include a type of non-volatile random-access memory (NVRAM) such as flash memory, solid-state memory, ferroelectric RAM (FeRAM), magnetoresistive RAM (MRAM) and/or phase-change memory.

Each of communication apparatus 410 and network apparatus 420 may be a communication entity capable of communicating with each other using various proposed schemes in accordance with the present disclosure. For illustrative purposes and without limitation, a description of capabilities of communication apparatus 410, as a UE, and network apparatus 420, as a network node (e.g., AMF/PCF), is provided below with processes 500 and 600.

### Illustrative Processes

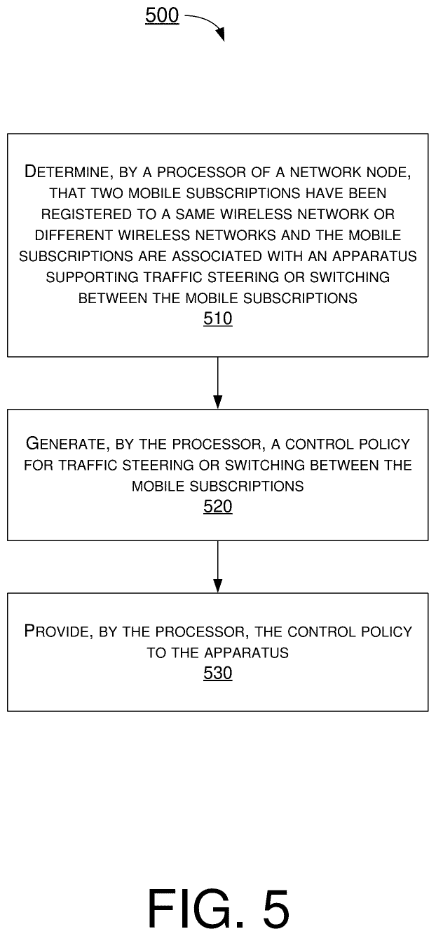

FIG. 5 illustrates an example process 500 in accordance with an implementation of the present disclosure. Process 500 may be an example implementation of above scenarios/schemes, whether partially or completely, with respect to enhanced policy control for traffic steering and switching between multiple mobile subscriptions. Process 500 may represent an aspect of implementation of features of network apparatus 420. Process 500 may include one or more operations, actions, or functions as illustrated by one or more of blocks 510 to 530. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by or in network apparatus 420 as well as any variations thereof. Solely for illustrative purposes and without limiting the scope, process 500 is described below in the context of communication apparatus 410, as a dual-steer device, and network apparatus 420, as a network node (e.g., AMF/PCF). Process 500 may begin at block 510.

At 510, process 500 may involve processor 422 of network apparatus 420 determining that two mobile subscriptions have been registered to a same wireless network or different wireless networks and the mobile subscriptions are associated with communication apparatus 410 supporting traffic steering or switching between the mobile subscriptions. Process 500 may proceed from 510 to 520.

At 520, process 500 may involve processor 422 generating a control policy for traffic steering or switching between the mobile subscriptions. Process 500 may proceed from 520 to 530.

At 530, process 500 may involve processor 422 providing, via transceiver 426, the control policy to communication apparatus 410.

In some implementations, the control policy may include at least one of the following: (i) an indication that TN access has higher priority than NTN access or that NTN access has higher priority than TN access; (ii) an indication that HPLMN has higher priority than VPLMN or that VPLMN has higher priority than HPLMN; and (iii) a list of one or more application-based entries.

In some implementations, each of the application-based entries may include a traffic descriptor for an application and a prioritized list of traffic steering or switching rules for the application.

In some implementations, the traffic descriptor comprises at least one of the following: (i) an application ID; (ii) a S-NSSAI; (iii) a DNN; (iv) an IP address; and (v) a FQDN.

In some implementations, each of the traffic steering or switching rules may include at least one of the following: (i) one or more PLMN IDs; (ii) a range of PLMN IDs; (iii) one or more MCCs; (iv) a range of MCCs; (v) a wildcard PLMN or MCC; (vi) one or more cell IDs or TA IDs; (vii) one or more validity times; and (viii) one or more validity areas.

In some implementations, each of the traffic steering or switching rules may include at least one of the following: (i) one or more RATs; and (ii) access information indicating 3GPP access or non-3GPP access.

In some implementations, each of the traffic steering or switching rules may include at least one of the following: (i) one or more categories of RAT information, each indicating TN, NTN, or IoT NTN; and (ii) an indication of a primary subscription or a secondary subscription.

In some implementations, each of the validity times may include at least one of: (i) a starting time, (ii) an ending time, (iii) a starting day, (iv) an ending day, and (v) a day of week. Each of the validity areas may indicate at least one of: (i) a 3GPP location; and (ii) a geolocation.

In some implementations, the 3GPP location may include at least one of the following: (i) a PLMN ID; (ii) a RAT; (iii) a TA or a RA; (iv) a frequency band; (v) a TAC; (vi) an E-UTRA CI; and (vii) an NR CI.

In some implementations, the control policy may be generated based on at least one of the following: (i) a principle that traffic of applications is preferred to be transmitted over TN access when the mobile subscriptions have been registered on both TN access and NTN access; (ii) a principle that traffic of applications is preferred to be transmitted over an HPLMN than a VPLMN; and (iii) the currently registered same wireless network or different wireless networks, and corresponding access information.

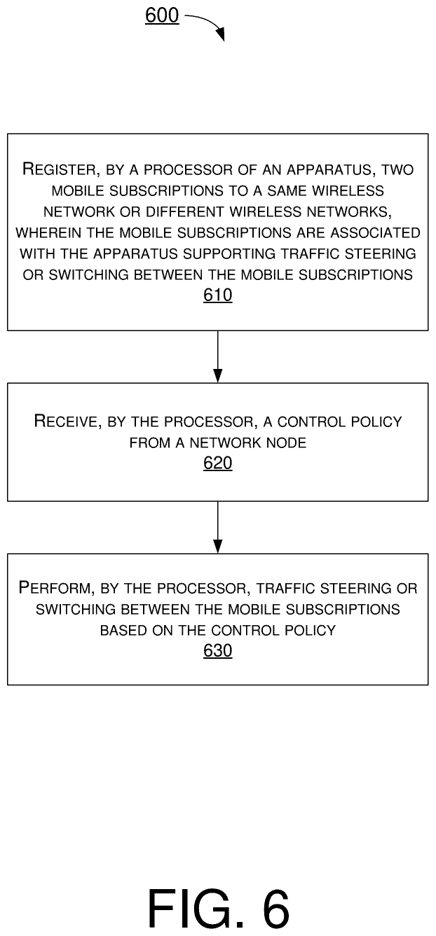

FIG. 6 illustrates an example process 600 under schemes in accordance with an implementation of the present disclosure. Process 600 may represent an aspect of implementing various proposed designs, concepts, schemes, systems and methods described above, whether partially or entirely, with respect to enhanced policy control for traffic steering and switching between multiple mobile subscriptions. Process 600 may represent an aspect of implementation of features of communication apparatus 410. Process 600 may include one or more operations, actions, or functions as illustrated by one or more of blocks 610 to 630. Although illustrated as discrete blocks, various blocks of process 600 may be divided into additional blocks, combined into fewer blocks, or eliminated, depending on the desired implementation. Moreover, the blocks/sub-blocks of process 600 may be executed in the order shown in FIG. 6 or, alternatively, in a different order. Process 600 may be implemented by or in communication apparatus 410 or any suitable UE or machine type device. Solely for illustrative purposes and without limiting the scope, process 600 is described below in the context of communication apparatus 410, as a dual-steer device, and network apparatus 420, as a network node (e.g., AMF/PCF). Process 600 may begin at block 610.

At 610, process 600 may involve processor 412 of communication apparatus 410 registering, via transceiver 416, two mobile subscriptions to a same wireless network or different wireless networks, wherein the mobile subscriptions are associated with communication apparatus 410 supporting traffic steering or switching between the mobile subscriptions. Process 600 may proceed from 610 to 620.

At 620, process 600 may involve processor 412 receiving, via transceiver 416, a control policy from network apparatus 420. Process 600 may proceed from 620 to 630.

At 630, process 600 may involve processor 412 performing traffic steering or switching between the mobile subscriptions based on the control policy.

In some implementations, the control policy may include at least one of the following: (i) an indication that TN access has higher priority than NTN access or that NTN access has higher priority than TN access; (ii) an indication that HPLMN has higher priority than VPLMN or that VPLMN has higher priority than HPLMN; and (iii) a list of one or more application-based entries.

In some implementations, each of the application-based entries may include a traffic descriptor for an application and a prioritized list of traffic steering or switching rules for the application.

In some implementations, the traffic descriptor comprises at least one of the following: (i) an application ID; (ii) a S-NSSAI; (iii) a DNN; (iv) an IP address; and (v) a FQDN.

In some implementations, each of the traffic steering or switching rules may include at least one of the following: (i) one or more PLMN IDs; (ii) a range of PLMN IDs; (iii) one or more MCCs; (iv) a range of MCCs; (v) a wildcard PLMN or MCC; (vi) one or more cell IDs or TA IDs; (vii) one or more validity times; and (viii) one or more validity areas.

In some implementations, each of the traffic steering or switching rules may include at least one of the following: (i) one or more RATs; and (ii) access information indicating 3GPP access or non-3GPP access.

In some implementations, each of the traffic steering or switching rules may include at least one of the following: (i) one or more categories of RAT information, each indicating TN, NTN, or IoT NTN; and (ii) an indication of a primary subscription or a secondary subscription.

In some implementations, each of the validity times may include at least one of: (i) a starting time, (ii) an ending time, (iii) a starting day, (iv) an ending day, and (v) a day of week. Each of the validity areas may indicate at least one of: (i) a 3GPP location; and (ii) a geolocation.

In some implementations, the 3GPP location may include at least one of the following: (i) a PLMN ID; (ii) a RAT; (iii) a TA or a RA; (iv) a frequency band; (v) a TAC; (vi) an E-UTRA CI; and (vii) an NR CI.

In some implementations, communication apparatus 410 may include a single UE with the mobile subscriptions for non-simultaneous transmission or include two UEs with which the mobile subscriptions are associated respectively for simultaneous transmission.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
determining, by a processor of a network node, that two mobile subscriptions have been registered to a same wireless network or different wireless networks and the mobile subscriptions are associated with an apparatus supporting traffic steering or switching between the mobile subscriptions;
generating, by the processor, a control policy for traffic steering or switching between the mobile subscriptions; and
providing, by the processor, the control policy to the apparatus.

2. The method of claim 1, wherein the control policy comprises at least one of the following:
an indication that terrestrial network (TN) access has higher priority than non-terrestrial network (NTN) access or that NTN access has higher priority than TN access;
an indication that home public land mobile network (HPLMN) has higher priority than visited public land mobile network (VPLMN) or that VPLMN has higher priority than HPLMN; and
a list of one or more application-based entries.

3. The method of claim 2, wherein each of the application-based entries comprises a traffic descriptor for an application and a prioritized list of traffic steering or switching rules for the application.

4. The method of claim 3, wherein the traffic descriptor comprises at least one of the following:
an application identifier (ID);
a single-network slice selection assistance information (S-NSSAI);
a data network name (DNN);
an internet protocol (IP) address; and
a fully-qualified domain name (FQDN).

5. The method of claim 3, wherein each of the traffic steering or switching rules comprises at least one of the following:
one or more PLMN IDs;
a range of PLMN IDs;
one or more mobile country codes (MCCs);
a range of MCCs;
a wildcard PLMN or MCC;
one or more cell IDs or tracking area (TA) IDs;
one or more validity times; and
one or more validity areas.

6. The method of claim 3, wherein each of the traffic steering or switching rules comprises at least one of the following:
one or more radio access technologies (RATs); and
access information indicating 3GPP access or non-3GPP access.

7. The method of claim 3, wherein each of the traffic steering or switching rules comprises at least one of the following:
one or more categories of radio access technology (RAT) information, each indicating TN, NTN, or IoT NTN; and
an indication of a primary subscription or a secondary subscription.

8. The method of claim 5, wherein each of the validity times comprises at least one of a starting time, an ending time, a starting day, an ending day, and a day of week, and each of the validity areas indicates at least one of a third generation partnership project (3GPP) location and a geolocation.

9. The method of claim 8, wherein the 3GPP location comprises at least one of the following:
a PLMN ID;
a radio access technology (RAT);
a TA or a routing area (RA);
a frequency band;
a tracking area code (TAC);
an evolved-universal terrestrial radio access (E-UTRA) cell identity (CI); and
a new radio (NR) CI.

10. The method of claim 1, wherein the control policy is generated based on at least one of the following:
a principle that traffic of applications is preferred to be transmitted over terrestrial network (TN) access when the mobile subscriptions have been registered on both TN access and non-terrestrial network (NTN) access;
a principle that traffic of applications is preferred to be transmitted over a home public land mobile network (HPLMN) than a visited public land mobile network (VPLMN); and
the currently registered same wireless network or different wireless networks, and corresponding access information.

11. A method, comprising:
registering, by a processor of an apparatus, two mobile subscriptions to a same wireless network or different wireless networks, wherein the mobile subscriptions are associated with the apparatus supporting traffic steering or switching between the mobile subscriptions;
receiving, by the processor, a control policy from a network node; and
performing, by the processor, traffic steering or switching between the mobile subscriptions based on the control policy.

12. The method of claim 11, wherein the control policy comprises at least one of the following:
an indication that terrestrial network (TN) access has higher priority than non-terrestrial network (NTN) access or that NTN access has higher priority than TN access;
an indication that home public land mobile network (HPLMN) has higher priority than visited public land mobile network (VPLMN) or that VPLMN has higher priority than HPLMN; and
a list of one or more application-based entries.

13. The method of claim 12, wherein each of the application-based entries comprises a traffic descriptor for an application and a prioritized list of traffic steering or switching rules for the application.

14. The method of claim 13, wherein the traffic descriptor comprises at least one of the following:
an application identifier (ID);
a single-network slice selection assistance information (S-NSSAI);
a data network name (DNN);
an internet protocol (IP) address; and
a fully-qualified domain name (FQDN).

15. The method of claim 13, wherein each of the traffic steering or switching rules comprises at least one of the following:
one or more PLMN IDs;
a range of PLMN IDs;
one or more mobile country codes (MCCs);
a range of MCCs;
a wildcard PLMN or MCC;
one or more cell IDs or tracking area (TA) IDs;
one or more validity times; and
one or more validity areas.

16. The method of claim 13, wherein each of the traffic steering or switching rules comprises at least one of the following:
one or more radio access technologies (RATs); and
access information indicating 3GPP access or non-3GPP access.

17. The method of claim 13, wherein each of the traffic steering or switching rules comprises at least one of the following:
one or more categories of radio access technology (RAT) information, each indicating TN, NTN, or IoT NTN; and
an indication of a primary subscription or a secondary subscription.

18. The method of claim 15, wherein each of the validity times comprises at least one of a starting time, an ending time, a starting day, an ending day, and a day of week, and each of the validity areas indicates at least one of a third generation partnership project (3GPP) location and a geolocation.

19. The method of claim 18, wherein the 3GPP location comprises at least one of the following:
a PLMN ID;
a radio access technology (RAT);
a TA or a routing area (RA);
a frequency band;
a tracking area code (TAC);
an evolved-universal terrestrial radio access (E-UTRA) cell identity (CI); and
a new radio (NR) CI.

20. The method of claim 11, wherein the apparatus comprises a single user equipment (UE) with the mobile subscriptions for non-simultaneous transmission or comprises two UEs with which the mobile subscriptions are associated respectively for simultaneous transmission.
